(19) United States
(12) Patent Application Publication
(10) Pub. No.: US 2006/0001576 A1
(43) Pub. Date: Jan. 5, 2006

(54) Compact, multi-element volume reuse antenna

(75) Inventor: Harry F. Contopanagos, San Diego, CA (US)

Correspondence Address: FOLEY & LARDNER LLP, P.O. BOX 80278, SAN DIEGO, CA, 92138-0278, US

(73) Assignee: Ethertronics, Inc.

(21) Appl. No.: 10/882,424

(22) Filed: Jun. 30, 2004

(51) Int. Cl. H01Q 1/24

(52) U.S. Cl. 343/702

(57) ABSTRACT

An antenna is disclosed having first and second portions which do not include a direct current connection between the portions. An antenna feed can be included for exciting the first portion and the second portion can be connected to ground and excited by electro-magnetic coupling with the first portion. In one embodiment the first portion is not connected to ground. The first and second portions can create substantially linearly independent current distributions. The antenna can be configured to have multiple modes adjacent in frequency such that they combine to form a larger bandwidth for the antenna.

### FIELD OF THE INVENTION

The present invention relates generally to the field of antennas. More specifically, the present invention relates to compact, multi-element antennas.

### BACKGROUND INFORMATION

Many wireless applications require a relatively large bandwidth. In order to achieve this large bandwidth, many wireless devices are required to employ either a large antenna element or multiple antenna elements. This solution is not practical for wireless devices which require the antenna to be accommodated in a relatively small package, thus requiring that the antenna have a low profile.

Further, certain wireless communication applications, such as the Global System for Mobile Communication (GSM) and Personal Communications Service (PCS) require that multiple bands be accessible, depending upon the local frequency coverage available from a service provider. Because applications such as GSM and PCS are used in the context of wireless communications devices that have relatively small form-factors, an antenna should generally have a low profile.

Embodiments of the present invention address the requirements of certain wireless communication applications by providing low-profile antennas that may provide a larger bandwidth.

### SUMMARY OF THE INVENTION

One embodiment of the invention relates to antennas designed with increased bandwidth and decreased size. One embodiment of an antenna according to the present invention includes a first portion, a second portion, an antenna feed, and a ground. The second portion is configured so that it does not have a direct current conductive path with the first portion. The antenna feed is configured for exciting the first portion and the first portion is not grounded. The ground is connected to the second portion and the second portion is fed through electro-magnetic coupling with the first portion.

The first and second portions can be configured to-create substantially linearly independent current distributions. The antenna can be configured to generate a symmetrical current distribution in a first mode and an anti-symmetrical current distribution in a second mode. In some applications, the first mode and the second mode are adjacent in frequency such that the bandwidth of the antenna is increased by the combination of the first mode and the second mode.

The antenna feed can be a direct feed coupled to the first portion or an indirect feed coupled to the first portion. Sample indirect feeds can include proximity inductive coupling, proximity capacitive coupling, and proximity slot coupling.

The antenna can also include an interstitial portion (or multiple interstitial portions) electromagnetically coupled to the first portion and the second portion. In addition, the first and/or second portions can further comprise a plurality of unconnected portions electromagnetically coupled together such that the plurality of unconnected portions participate in the overall excitation of the respective portion. Parasitic elements can also be included such as for the purpose of impedance matching the antenna.

Other principal features and advantages of the invention will become apparent to those skilled in the art upon review of the following drawings, the detailed description, and the appended claims.

### BRIEF DESCRIPTION OF THE DRAWINGS

The preferred embodiments will hereafter be described with reference to the accompanying drawings, wherein like numerals will denote like elements.

FIGS. 1a-h are diagrammatical representations of various embodiments of antennas according to the present invention.

FIG. 2 is a graphical representation of the frequency response of one embodiment of an antenna according to the present invention.

FIG. 3 is a diagrammatical representation of an alternative embodiment of an antenna according to the present invention.

FIG. 4 is a graphical representation of the frequency response of another embodiment of an antenna according to the present invention.

FIG. 5 is a diagrammatical representation of the vector current density distribution of one embodiment of an antenna according to the present invention at a first mode frequency.

FIG. 6 is a diagrammatical representation of the vector current density distribution of one embodiment of an antenna according to the present invention at a second mode frequency.

### DETAILED DESCRIPTION OF THE PREFERRED EMBODIMENTS

Antennas according to the present invention can be used to produce larger bandwidths than other antennas of the same size. By reusing volume, antennas according to the present invention can be made smaller than other conventional antennas. Antennas according to the present invention can have multiple modes that exist in separate frequencies arbitrarily near each other. The electromagnetic field distribution in the space near the antennas, corresponding to each mode, can have very different spatial characteristics for each mode. Since the modes can be designed to be very close to each other in frequency, the bandwidth of the antennas can be increased using the same physical volume occupied by conventional antennas having a smaller bandwidth. Within the multiply increased bandwidth, embodiments of the antennas according to the present invention can have excellent radiation efficiency. Thus, antennas according to the present invention can be used to produce smaller size antennas while keeping the bandwidth and radiative efficiency performance of larger conventional antennas.

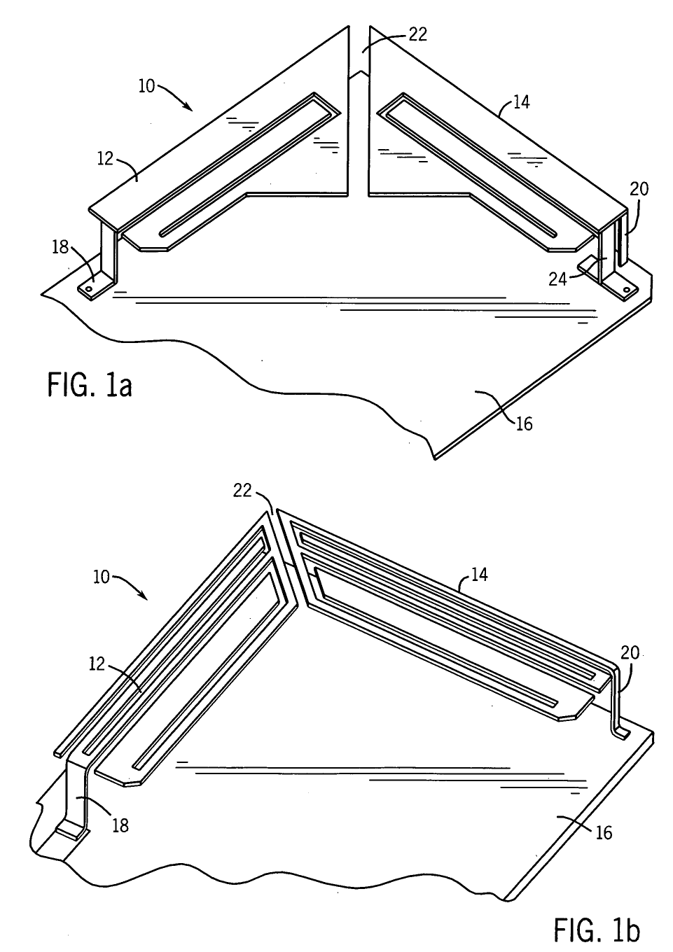

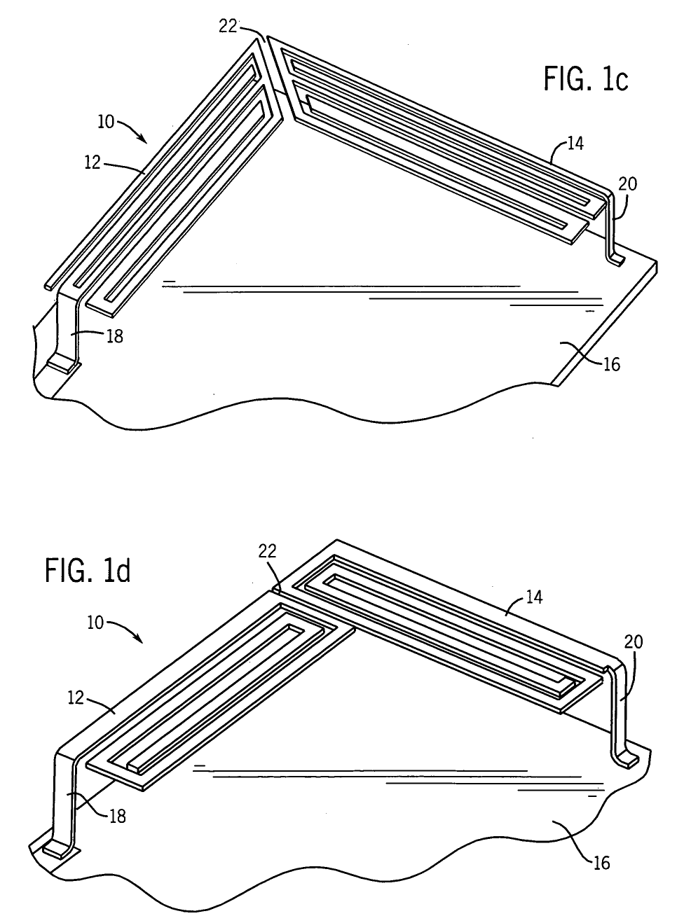

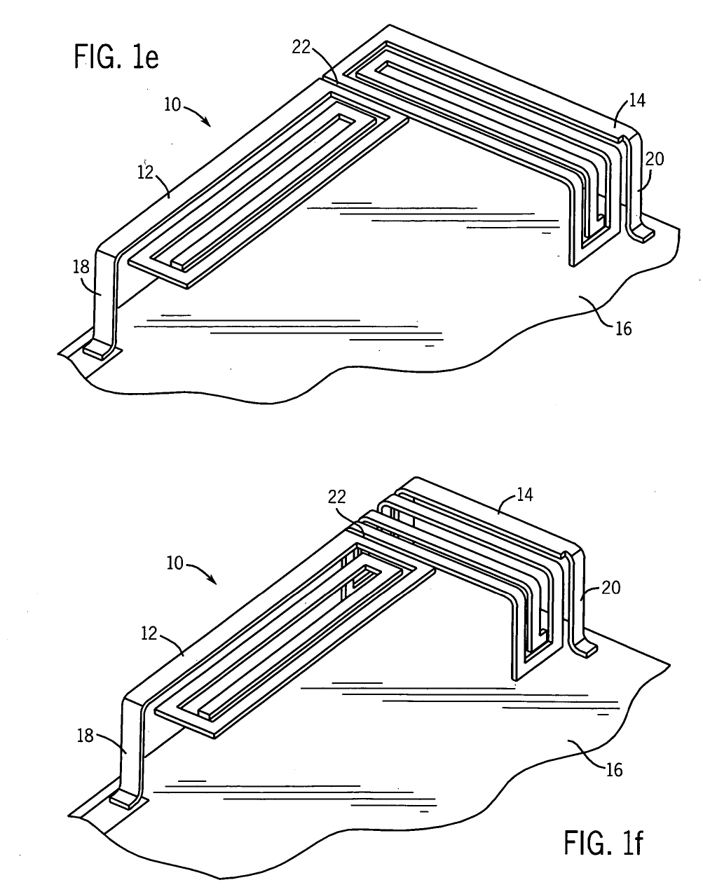

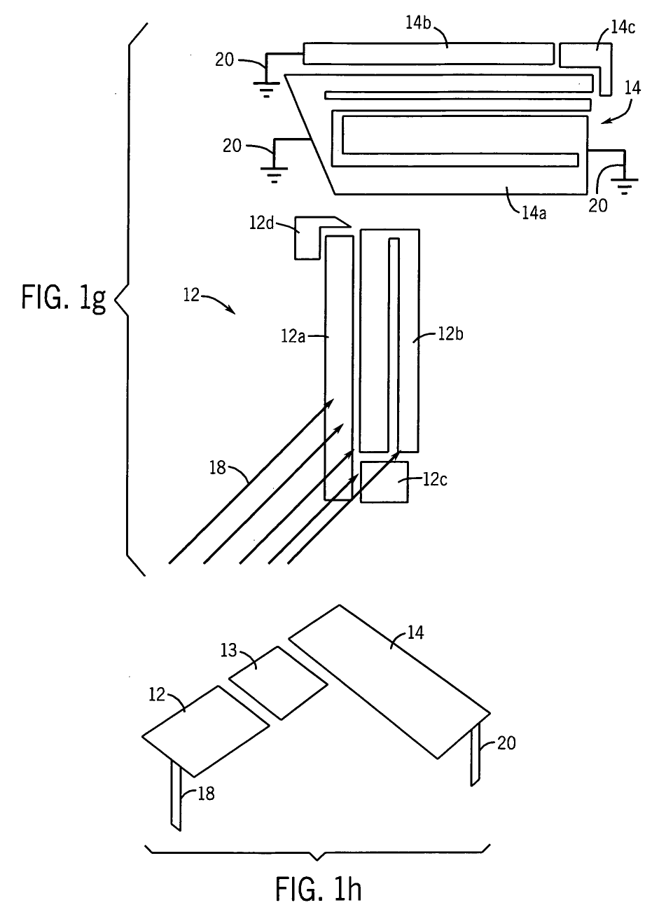

Referring now to FIG. 1a, one embodiment of an antenna is generally designated with reference numeral 10. The antenna 10 comprises two elements 12 and 14 and a ground plane 16. An antenna feed 18 is connected to element 12 and a ground connection 20 is connected to element 14. Element 12 is not directly connected to ground and element 14 is not directly connected to a signal feed. In other words, no direct current path exists between elements 12 an 14. Instead, elements 12 and 14 are electromagnetically coupled to each other through a coupling region 22 by their relative proximity and orientation, but are not directed connected to each other. An optional support element 24 can also be added to either element 12 and/or 14 for providing structural support.

Elements 12 and 14 can be formed of and comprise any number of materials such as but not limited to, stamped metal, printed circuit technology, metal tape or paint, or any other metallization or conductive medium method. Furthermore, the present invention is applicable to a variety of antenna 10 and elements 12 and 14 sizes and frequencies. Various geometrical antenna features, such as but not limited to various geometries of radiative slots, edges or stubs, as well as single or multilevel stamped metal, printed metal, and/or metal paint technologies can be used. The elements 12 and 14 can be positioned on the same plane or on different planes and, in fact, various embodiments of the antenna 10 can comprise more than two elements. The elements 12 and 14 can be radiating holes or other openings existing on a metallic or otherwise conductive screen or any other structure that complies with Babinet's principle. The element design, coupling region design and size of the antenna can be varied in different embodiments of the invention. For example, FIGS. 1b-1f illustrate additional examples of embodiments of an antenna 10 according to the present invention.

Embodiments of the invention can be fed in many different ways. While the embodiment shown in FIG. 1 includes a direct feed 18, other excitation methods can also be used. For example, indirect feeds, such as proximity inductive and/or capacitive coupling or proximity slot coupling, among others, can be used to excite element 12. FIG. 1g illustrates one embodiment using an alternative excitation method in which element 12 is fed using an indirect feed 18. In the antenna illustrated in FIG. 1g, it can be seen that elements 12 and 14 can include multiple unconnected portions 12a-12d and 14a-14c, respectively. Some of the unconnected portions of element 12, such as elements 12a and 12b may participate in the overall excitation of element 12, while other portions, such as elements 12c and 12d, may be parasitic elements used, for example for input impedance matching. In addition, element 14 may also include portions that are not grounded and act as parasitic elements, such as element 14c. Separate grounds can be used for the unconnected portions of element 14, such as elements 14a and 14b, for impedance matching for example. Further, one or more unconnected portions of element 14 can have multiple connections to ground.

Another alternative embodiment of an antenna 10 according to the present invention is illustrated in FIG. 1h. The antenna of Fig. 1h includes an interstitial portion 13 between elements 12 and 14. As shown in this figure, interstitial portion 13 has no direct feed or ground nor a direct current path coupling it to elements 12 or 14. Instead, element 13 can be feed through electromagnetic coupling with elements 12 and 14. Additional alternative embodiments of antennas according to the present invention (not shown) may include multiple interstitial portions which electromagnetically couple to elements 12 and 14.

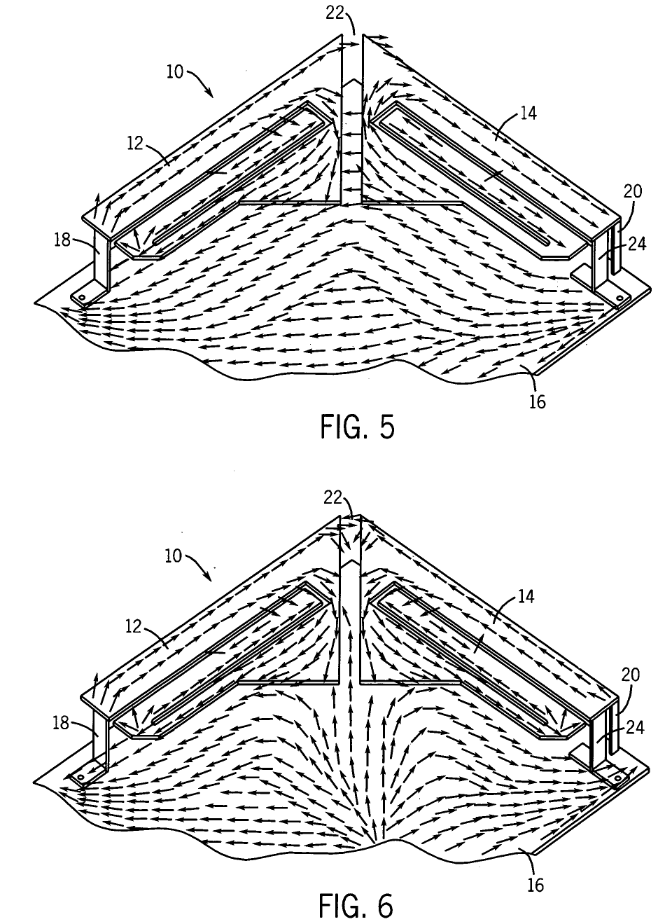

In effect, embodiments of the invention can create multiple modes in adjustably adjacent frequencies. The embodiments can be configured to produce substantially linearly independent current distributions, such as orthogonal or substantially orthogonal. For example, embodiments can comprise symmetric (for the first mode) and anti-symmetric (for the second mode) current density distributions. For example, symmetric and anti-symmetric combinations of current distributions can occur on elements 12 and 14. A symmetric distribution is one where all antenna parts have the same current distribution as defined by the right-hand rule. An anti-symmetric distribution can be one where some antenna parts have opposite current distributions. These two types of current distributions can create dramatically different electromagnetic field distributions in a space immediately surrounding the antenna 10. Alternative embodiments of symmetric and anti-symmetric current distributions may involve linear current distributions, rather than the circular ones shown in the example of FIGS. 5 and 6. In such a case, the symmetric linear current distribution could be linear currents that flow continuously from one portion (entering the coupling region for example) to another portion (exiting the coupling region for example), while the anti-symmetric current distributions could be linear currents that both enter the coupling region or both exit the coupling region for example in opposite directions. Creating symmetric current distributions in one mode and anti-symmetric current distributions in another mode is one example of creating substantially linearly independent current distributions according to the present invention.

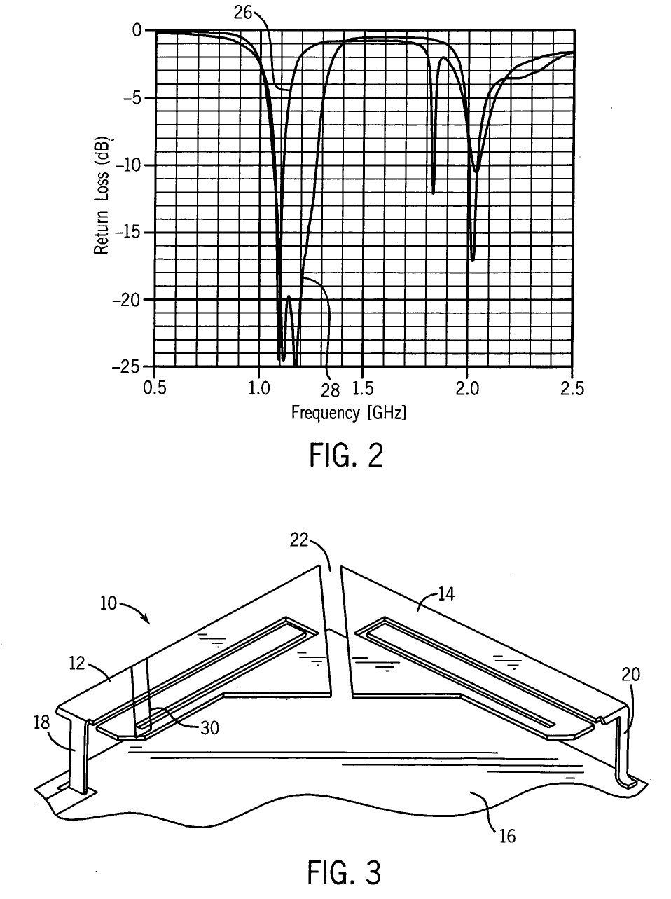

Elements 12 and 14 can be excited by feed 18 connected to element 12 to produce two modes that resonate at different frequencies. In one embodiment, the mode frequencies can be designed as close to each other as possible. As the modes become closer in frequency, the antenna 10 can match well over the bandwidth of both modes, thus multiplying the overall bandwidth of the antenna 10, relative to other antennas of approximately the same size. FIG. 2 illustrates a comparison of the measured return loss of a conventional embedded antenna (line 26) with the measured response of one embodiment of an antenna of relatively the same size according to the present invention (line 28).

In one embodiment, the frequency separation between the modes can be controlled by the radiating length of each element 12 and 14, for example, the total length of the slot or spiral of the embodiments shown in FIGS. 1a-1f. The frequency separation can also be controlled by the amount of coupling between the elements 12 and 14. In one embodiment, the amount of coupling is controlled by adjusting the width of the coupling region 22 between the elements 12 and 14. As described herein, various other geometries producing other coupling details may also be used. The elements 12 and 14 can be symmetric or dissimilar and they can be arranged orthogonal or in various other arrangements and configurations.

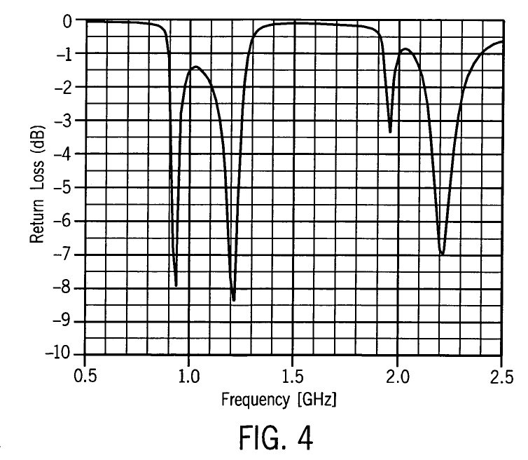

In another embodiment, shown in FIG. 3, a ground connection 30 can also be added to element 12. This ground connection 30 can be used to separate the two modes further apart in frequency, as illustrated in FIG. 4. Even though, in such an embodiment, elements 12 and 14 are physically connected through the common ground plane, the two corresponding grounding locations are still not directly connected by a current conducting path, because these locations are at the same (ground) potential and a non-negligible current conducting path needs a non-negligible potential difference in order to be established. When the modes are sufficiently separated they produce multiple distinct bands. The mode of separation in such an embodiment can further be controlled by positioning of ground connection 30 within the first portion of the antenna. In this case, the antenna 10 can be configured to operate as a multi-band antenna.

As described herein, embodiments of the invention can include symmetric and anti-symmetric current distributions. FIG. 5 illustrates one possible current distribution for the embodiment illustrated in FIG. 1. The vector current density distribution shown in FIG. 5 illustrates the current distribution at the frequency of the first mode. As is shown, the current distribution circulates clockwise around the slot (as viewed looking down on the antenna 10 from the top) on both the elements 12 and 14. This is a symmetric current distribution with respect to elements 12 and 14. The magnetic field lines thread the volume enclosed by the antenna 10 and the ground plane 16 roughly along the coupling region 22.

FIG. 6 illustrates one possible vector current density distribution for the antenna 10 of FIG. 1 at the frequency of the second mode. As can be seen, the current distribution circulates clockwise around the slot on element 12 and counter-clockwise around the slot on element 14. This can be considered an anti-symmetric current distribution. The magnetic field lines thread the volume enclosed by the antenna 10 and the ground plane 16 roughly perpendicular to the coupling region 22.

When the antenna 10 is designed so that the modes are adjacent in frequency, an increase in bandwidth by multiple factors can be achieved. Similar or even better radiation efficiency can also be achieved for the antenna 10 over that broad band. In addition, antennas according to the present invention have incomparably higher efficiency for frequencies that are in-band for antennas 10 in accordance with the present invention but out-of-band for other antennas.

It is understood that the invention is not confined to the particular embodiments set forth herein as illustrative, but embraces all such modifications, combinations, and permutations as come within the scope of the appended claims. Thus, the description of the preferred embodiments is for purposes of illustration and not limitation.

What is claimed is:

1. An antenna comprising:
a first portion;
a second portion having no direct current conductive path with the first portion;
an antenna feed configured for exciting the first portion; and
a ground connected to the second portion;
wherein the second portion is fed through electro-magnetic coupling with the first portion.

2. The antenna of claim 1, wherein the first and second portions create substantially linearly independent current distributions.

3. The antenna of claim 1, wherein the antenna is configured to generate a symmetric current distribution in a first mode and an anti-symmetric current distribution in a second mode.

4. The antenna of claim 3, wherein the first mode and the second mode are adjacent in frequency such that the bandwidth of the antenna is increased by the combination of the first mode and the second mode.

5. The antenna of claim 1, wherein the antenna feed is a direct feed coupled to the first portion.

6. The antenna of claim 1, wherein the antenna feed is an indirect feed coupled to the first portion.

7. The antenna of claim 6, wherein the antenna feed is proximity inductive coupled, proximity capacitive coupled, or proximity slot coupled to the first portion.

8. The antenna of claim 1, further comprising an interstitial portion electromagnetically coupled to the first portion and the second portion.

9. The antenna of claim 8, further comprising a plurality of interstitial portions electromagnetically coupled to each other and/or the first portion and/or the second portion.

10. The antenna of claim 1, wherein the first portion further comprises a plurality of unconnected portions electromagnetically coupled together such that the plurality of unconnected portions participate in the overall excitation of the first portion.

11. The antenna of claim 10, further comprising at least one parasitic element coupled to the first portion.

12. The antenna of claim 11, wherein the at least one parasitic element is used for impedance matching the antenna.

13. A antenna of claim 1, wherein second portion further comprises a plurality of unconnected portions electromagnetically coupled together such that the plurality of unconnected portions participate in the overall excitation of the second portion.

14. The antenna of claim 13, wherein each of the unconnected portions of the second portion is connected to ground.

15. The antenna of claim 13, further comprising at least one parasitic element.

16. The antenna of claim 1 wherein the first and second portions further comprise stamped conductive material, printed conductive material, conductive tape, or conductive paint.

17. The antenna of claim 1, wherein the first and second portions further comprise radiative slots or openings.

18. An antenna comprising:
a first portion;
a second portion having no direct current conductive path with the first portion;
an antenna feed for exciting the first portion; and
a ground connected to the second portion;
wherein the second portion is fed through electro-magnetic coupling with the first portion and wherein the first and second portions create substantially linearly independent current distributions.

19. The antenna of claim 18, wherein the first portion is not grounded.

20. The antenna of claim 18, wherein the first portion is grounded.

21. The antenna of claim 18, wherein the antenna is configured to generate a symmetric current distribution in a first mode and an anti-symmetric current distribution in a second mode.

22. The antenna of claim 20, wherein the first mode and the second mode are adjacent in frequency such that the bandwidth of the antenna is increased by the combination of the first mode and the second mode.

23. The antenna of claim 18, wherein the antenna feed is a direct feed coupled to the first portion.

24. The antenna of claim 18, wherein the antenna feed is an indirect feed coupled to the first portion.

25. The antenna of claim 23, wherein the antenna feed is proximity inductive coupled, proximity capacitive coupled, or proximity slot coupled to the first portion.

26. The antenna of claim 18, further comprising an interstitial portion electromagnetically coupled to the first portion and the second portion.

27. The antenna of claim 25, further comprising a plurality of interstitial portions electromagnetically coupled to each other and/or the first portion and/or the second portion.

28. The antenna of claim 18, wherein the first portion further comprises a plurality of unconnected portions electromagnetically coupled together such that the plurality of unconnected portions participate in the overall excitation of the first portion.

29. The antenna of claim 27, further comprising at least one parasitic element coupled to the first portion.

30. The antenna of claim 28, wherein at least one parasitic element is used for impedance matching the antenna.

31. A antenna of claim 18, wherein the second portion further comprises a plurality of unconnected portions electromagnetically coupled together such that the plurality of unconnected portions participate in the overall excitation of the second portion.

32. The antenna of claim 30, wherein each of the unconnected portions of the second portion is connected to ground.

33. The antenna of claim 30, further comprising at least one parasitic element.

34. The antenna of claim 18, wherein the first and second portions further comprise stamped conductive material, printed conductive material, conductive tape, or conductive paint.

35. The antenna of claim 18, wherein the first and second portions define a volume of the antenna and wherein each of the substantially linearly independent current distributions shares the volume of the antenna.

36. The antenna of claim 18, wherein the antenna comprises more than two portions defining a volume of the antenna and wherein the more than two portions create more than two substantially linearly independent current distributions sharing the volume of the antenna.
